(19) United States
(12) Patent Application Publication
(10) Pub. No.: US 2016/0135112 A1
(43) Pub. Date: May 12, 2016

(54) ROUTER DEVICE

(71) Applicant: LOOPCOMM TECHNOLOGY, INC., New Taipei City (TW)

(72) Inventor: Hsien-Lu Lin, New Taipei City (TW)

(21) Appl. No.: 14/580,829

(22) Filed: Dec. 23, 2014

(30) Foreign Application Priority Data
Nov. 7, 2014 (TW) 103138748

(51) Int. Cl. H04W 40/24; H04L 12/751

(52) U.S. Cl. CPC H04W 40/246; H04L 45/02; H04W 88/10

(57) ABSTRACT

Disclosed is a router device for transmitting and receiving a networking signal via a network connection. The network connection includes a wireless connection or a wired network connection. The router device comprising: a wireless networking means for transmitting and/or receiving the networking signal within the wireless network connection, a wired networking means for transmitting and receiving the networking signal by a wire within the wired network connection, a memory for storing picture data, and a touch screen for inputting a network configuration of the wireless network connection and/or the wired network connection, for displaying the result of network configuration, and for displaying the picture data.

### RELATED APPLICATIONS

This application claims priority to Taiwanese Application No, 103138748, filed on Nov. 7, 2014, the disclosure of which is incorporated herein by reference in its entirety.

### FIELD OF THE INVENTION

The present invention relates to a router device, and more particularly, to a router device capable of directly performing network configuration thereon.

### BACKGROUND OF THE INVENTION

A router device is a device that provides data transmission and communication of the routing function on the network layer between an Internet Service Provider (ISP) and a user's network device. A router device is primarily for determining the optimal path of data transmission and communication by use of a routing table. Moreover, a router device is generally provided with functions for configuring encryption and decryption of data in order to achieve the data security purposes.

As for the use of a conventional router device, it generally connects a router device to a personal computer, a laptop or any mobile data device via a wired network connection or a wireless network connection in order to perform the configuration of the router device, i.e., password configuration, encryption configuration, decryption configuration, etc. Since the conventional router device must be connected to a computer device for performing configurations, it is thus inconvenient.

Moreover, the conventional steps of connecting a computer device to a router device and then performing configuration of the router device needs to be undertaken by a user equipped with a high level of computer skills. Moreover, in the conventional technique, a user still needs to test the computer connecting status after the configurations are completed. It causes another inconvenience for users.

Thus, it has become an issue to have a router device that can be configured without other computer device. Moreover, it also becomes an issue to add other useful humanized functions in a router device which the above self configuring function.

### SUMMARY OF THE INVENTION

Therefore, an object of the present invention is to provide a router device which has a touch screen, the touch screen being for directly performing configuration of the router device thereon and displaying the configuration in progress and the final configuration, and furthermore for being taken as a digital picture frame.

In a technical viewpoint of the present invention, the present invention provides a router device for transmitting and receiving a networking signal via a network connection. The network connection includes a wireless connection or a wired network connection. The router device comprises:
a wireless networking means for transmitting and/or receiving the networking signal within the wireless network connection,
a wired networking means for transmitting and receiving the networking signal by a wire within the wired network connection,
a memory for storing picture data, and
a touch screen for inputting a network configuration of the wireless network connection and/or the wired network connection, for displaying the network configuration results, and for displaying the picture data.

According to an embodiment of the present invention, the touch screen serves the function of a digital picture frame.

According to an embodiment of the present invention, the touch screen is a liquid-crystal display module.

According to an embodiment of the present invention, the wireless networking means includes a WiFi module and a telecommunication module.

According to an embodiment of the present invention, the router device further includes a USB port and a RJ45 port.

According to an embodiment of the present invention, the telecommunication module is connected to a subscriber identity module (SIM) via a USB interface or a built-in socket.

According to an embodiment of the present invention, the router device further includes a battery means, which is removal as being free of screw.

According to an embodiment of the present invention, the battery means is a mobile power bank.

According to an embodiment of the present invention, the router device further includes a removable antenna means.

According to an embodiment of the present invention, the touch screen is connected to a processor of the router device via a microprocessor control unit.

The router device of the present invention has the following effects. The configuration of the router device can be directly performed on the touch screen, the touch screen can display the configuration in progress and the final configuration, and the touch screen can be used as a digital picture frame.

### BRIEF DESRIPTION OF THE DRAWINGS

FIG. 1 is a perspective view of a router device according to an embodiment of the present invention.

FIG. 2 is a block diagram illustrating the router device according to an embodiment of the present invention.

FIG. 3 is a schematic diagram illustrating an inputting screen on the touch screen according to an embodiment of the present invention.

FIG. 4 is a block diagram illustrating a touch screen according to an embodiment of the present invention.

FIG. 5 is a schematic diagram illustrating a digital picture on a touch screen according to an embodiment of the present invention.

### DETAILED DECRIPTION OF THE PREFERRED EMBODIMENTS

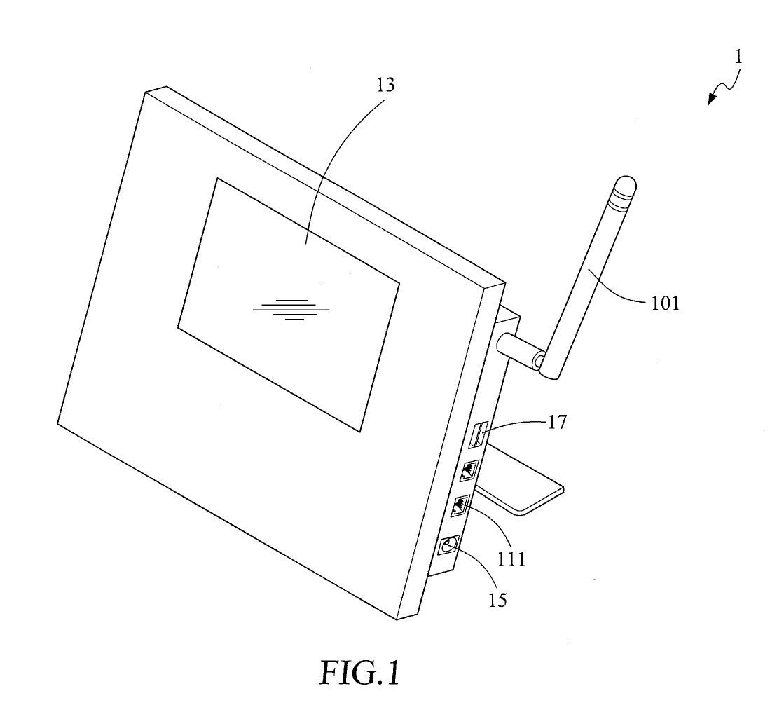

Embodiments are described in detail below with reference to the FIG. 1 to FIG. 5, and the description is used for explaining the embodiments of the present invention, but not intended to limit the described embodiments of the present invention.

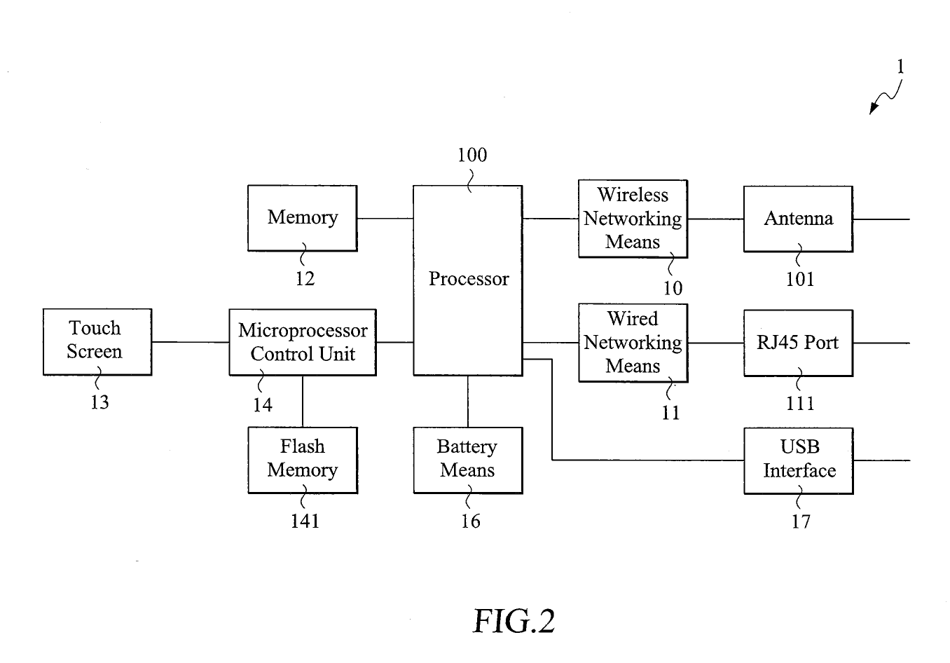

As shown in FIG. 1, it is a perspective view of a router device according to an embodiment of the present invention. The router device 1 is connected to an Internet service provider (ISP) via a RJ45 port 111 by a network wire (not shown) or an antenna 101 in order to transmit and receive a networking signal from the Internet service provider. That is, the router device 1 is able to be connected to a network via a wireless network connection or a wired network connection. The power of the router device 1 is supplied by a power supply (not shown) that is connected to a power source jack 15 or by a battery means 16, as shown in FIG. 2.

As shown in FIG. 2, it is a block diagram illustrating a router device 1 according to an embodiment of the present invention. The router device 1 includes a processor 100; a wireless networking means 10 for wireless transmission and reception of a networking signal within the wireless network; a wired networking means 11 for transmission and reception of the networking signal by a wire within the wired network; a memory 12 for storing picture data; a touch screen 13, which is connected to the processor 100 via a microprocessor control unit 14, for inputting the network configuration, for displaying the network configuration results, and for displaying the picture data. The picture data can be dynamically or statically displayed on the touch screen 13.

The wireless networking means 10 is connected between the antenna 101 and the processor 100 in order to transfer a networking signal between the antenna 101 and the processor 100. The wired networking means 11 is connected between the RJ45 port 111 and the processor 100 in order to transfer a networking signal between the RJ45 port 111 and the processor 100. The memory 12 is connected to the processor 100, and is able to store a networking signal during a network transmitting process and a network receiving process. The memory 12 is also able to store the network configuration results.

The touch screen 13 is connected to the processor 100 via the microprocessor control unit 14 in order to input the network configuration of the wireless network connection and/or wired network connection, to display the network configuration results, and to display the picture data. The signal transmission and signal reception of the touch screen 13 is directly handled by the microprocessor control unit 14. In this way, the image quality of the images on the touch screen 13 can be directly enhanced by advancing the image processing function of the microprocessor control unit 14 without the necessity of changing the processor 100. The image processing function includes the settings of image resolution, color, etc. The image processing function of the router device 1 can be more effectively enhanced, and the processing speed of a networking signal of the processor 100 can be increased. Moreover, the processor 100 can thus be allowed to have more different diversity of modules to therefore reduce the cost. Preferably, the microprocessor control unit 14 can be externally connected to a flash memory 141 in order to increase the flash memory capacity of the microprocessor control unit 14 to accelerate the speed of picture data displaying, signal processing, transmitting, receiving, etc.

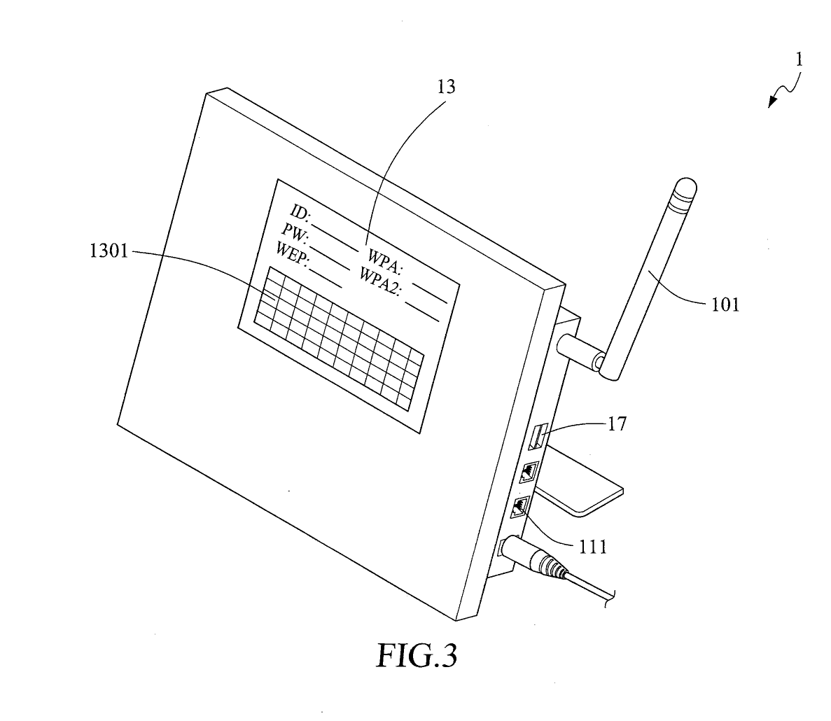

On the router device 1 shown in FIG. 1 and FIG. 2, a user is able to directly input the network configuration of the wireless network connection and/or wired network connection on the touch screen 13. The inconvenience of requiring an external computer device to configure a router device thus can be eliminated. As shown in FIG. 3, since the touch screen 13 is able to display an input keyboard component 1301, a user can directly input the configuration on the input keyboard component 1301, including: a user ID, a user password, data encryption options, such as WEP, WPA, WPA2, etc. Therefore, the inconvenience of requiring an external computer device to configure a router device can be eliminated.

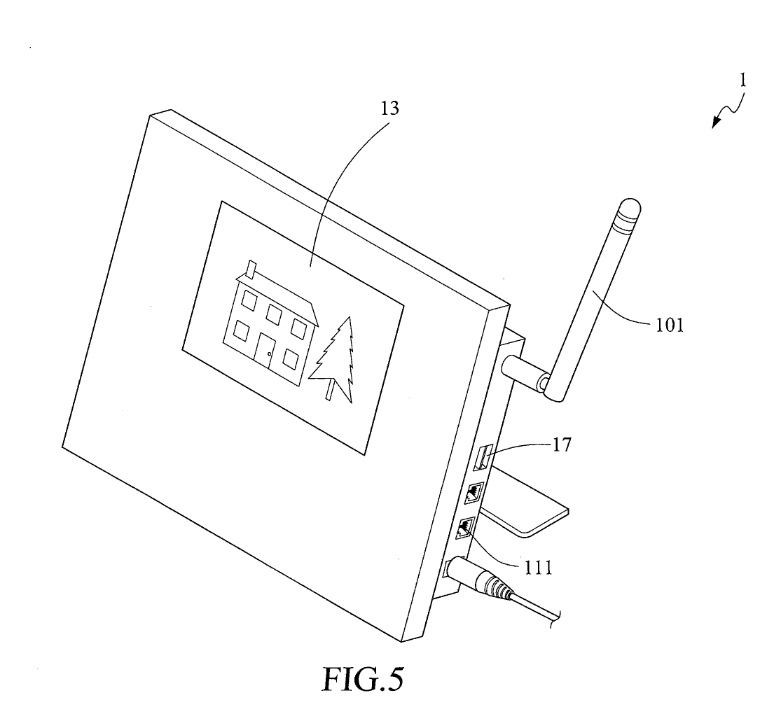

The router device 1 of the present invention is provided with a picture displaying function. By storing the selected picture data in the memory 12, or transmitting picture data to the touch screen 13 from other computer devices including a personal computer or a mobile computer device via a wired network connection or a wireless network connection, the touch screen 13 of the present invention can be used as a digital picture frame for displaying the picture as shown in FIG. 5.

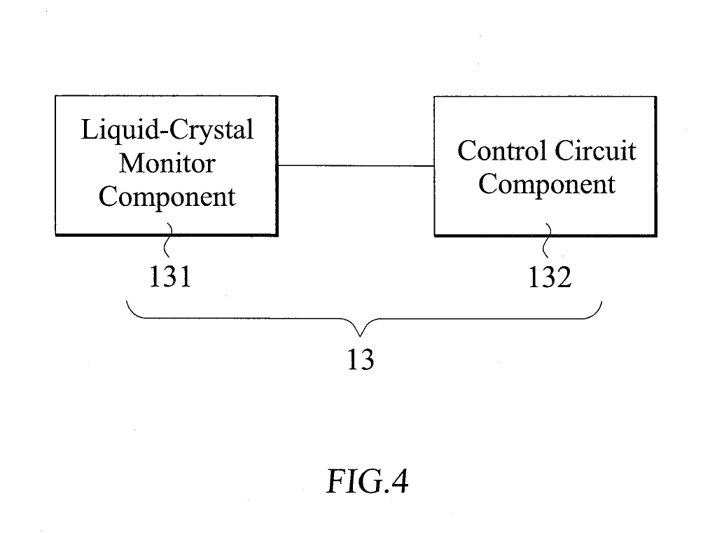

As shown in FIG. 4, according to the router device 1 of an embodiment of the present invention, the touch screen 13 is a liquid-crystal display module. The so-called liquid-crystal display module refers to a module that integrates a liquid-crystal monitor component 131 and a control circuit component 132 as a single chipset or packages the liquid-crystal monitor component 131 and the control circuit component 132 as a single component. Therefore, the complexity of selecting control circuit component 132 can be eliminated.

A wireless network connection can be a WiFi connection or transmission and reception modes of 3G, 3.5G or 4G telecommunication. Therefore, according to the router device 1 in an embodiment of the present invention, the wireless networking means 10 can include a WiFi module and a telecommunication module in order to receive a wireless networking signal.

As shown in FIG. 1, according to the router device 1 of an embodiment of the present invention, the router device 1 further includes a USB interface 17 for connecting to a subscriber identity module, commonly referred to as SIM, to perform transmission and reception of 3G, 3.5G or 4G telecommunication. The router device 1 may also be provided with a built-in interface, such as a SIM socket. With a SIM card inserted, the router device is applied to function as a wireless access point.

As shown in FIG. 2, according to the router device 1 in an embodiment of the present invention, the router device 1 can be connected to an indoor power supply without a wire by virtue of the battery means 16. By configuring the battery means as a mobile battery component or a power bank component, the power bank can charge or discharge when necessary. The battery means is removal as being free of screw,

As shown in FIG. 1, according to the router device 1 in an embodiment of the present invention, the antenna 101 is a removable antenna means and is rotatable. Further, it can be designed for different sizes depending on demands so as to furnish various demands of power transmission. Space usage can also be reduced.

The above descriptions should be considered as only the discussion of the preferred embodiments of the present invention. However, a person with an ordinary skill in the art may make modifications to the present invention, and those modifications still fall within the spirit and scope defined by the appended claims.

What is claimed is:

1. A router device for transmitting and receiving a networking signal via a network connection, the network connection including a wireless network connection and a wired network connection, the router device comprising:
a wireless networking means for transmitting and/or receiving the networking signal via the wireless network connection,
a wired networking means for transmitting and/or receiving the networking signal via the wired network connection,
a memory means for storing picture data, and
a touch screen for inputting a network configuration of the wireless network connection and/or the wired network connection, for displaying the network configuration results, and for displaying the picture data.

2. The router device as claimed in claim 1, wherein the touch screen is provided to function as a digital picture frame.

3. The router device as claimed in claim 1, wherein the touch screen is a liquid-crystal display means.

4. The router device as claimed in claim 1, wherein the wireless networking means includes a WiFi module and a telecommunication module.

5. The router device as claimed in claimed 1, further comprising a USB port and a RJ45 port.

6. The router device as claimed in claimed 4, wherein the telecommunication means is connected to a subscriber identity module (SIM) via a USB interface and/or a built-in socket.

7. The router device as claimed in claim 1, further comprising a battery means, which is removal as being free of screw.

8. The router device as claimed in claimed 7, wherein the battery means is a mobile power bank.

9. The router device as claimed in claim 1, further comprising a removable antenna.

10. The router device as claimed in claim 1, wherein the touch screen is connected to a processor of the router device via a microprocessor control unit.
